(19) United States
(12) Patent Application Publication
(10) Pub. No.: US 2005/0021469 A1
(43) Pub. Date: Jan. 27, 2005

(54) System and method for securing content copyright

(75) Inventor: Hee-chul Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/848,106

(22) Filed: May 19, 2004

(30) Foreign Application Priority Data
Jul. 22, 2003 (KR) 10-2003-0050169

(51) Int. Cl. G06F 17/60

(52) U.S. Cl. 705/51

(57) ABSTRACT

A content copyright security system and method thereof, wherein content provided from a content server to execution device is encrypted by a variety of encryption methods and the execution of the encrypted content in the execution device is made only when user authentication is performed through the content server and the execution device then receives an authentication key corresponding to one of the encryption methods from an authentication signal generating unit at a predetermined interval of time, thereby maintaining security for the content even in the execution device.

### BACKGROUND OF THE INVENTION

This application claims the priority of Korean Patent Application No. 10-2003-0050169 filed on Jul. 22, 2003, in the Korean Intellectual Property Office, the disclosure of which is incorporated herein in its entirety by reference.

1. Field of the Invention

The present invention relates to a system and a method for content copyright security, and more particularly, to a system and method for content copyright security, wherein content provided from a content server connected to an external system to an execution device is encrypted by a variety of encryption methods and the encrypted content in the execution device is set to be executed when user authentication is confirmed through the content server and the execution device then receives an authentication key corresponding to each of the encryption methods from an authentication signal generating unit at a regular interval of time, thereby allowing the execution of content to be controlled in the execution device.

2. Description of the Related Art

Recently it has become popularized to access, execute or download digital contents at distant areas through the Internet or communication networks.

As distribution of the digital content has been popularized, there have been developed a variety of techniques for providing reliable distribution environments to effectively prevent unauthorized copying of the digital contents and make profits through the use of contents between concerned parties of any transactions, in a legitimate manner.

Among them, digital rights management (hereinafter, referred to as ‘DRM’) typically has attracted attention. The DRM is defined, in a broad sense, as a technique, a procedure, a process or a program for managing copyrights for, e.g., hardware and software, which enables reliable license, secure copyright and authentication, and a reliable environment and infrastructure as a protection, management and distribution system for digital contents.

A basic function of DRM is to prevent unauthorized distribution of digital contents. For this purpose, DRM has widely used security techniques which protects the rights of a content owner and simultaneously allows a consumer to easily and legitimately obtain digital content.

Accordingly, the content owner provides only authenticated users with a decryption means corresponding to a predetermined encryption method, encrypts content and then transmits the encrypted content to the users, so that the users can decrypt the encrypted content by using the decryption means and then use the decrypted content.

Such a content security method provides a high level of security in the one-to-one use of content between concerned parties in a transaction.

However, when a network device connected to and operated in a given network decrypts encrypted content through a network access server connected to an external network and uses the decrypted content, content copyright security for the network device that uses the content provided from the network access server has not yet been achieved.

In other words, a network access server (hereinafter referred to as ‘content server’) connected to the external network receives a content file from a content owner through a wired/wireless communication network such as a broadcast station or the Internet and then decrypts the file by using a predetermined decryption means.

Then, the content server encrypts the decrypted content file by means of its own encryption method and then transmits the encrypted content to network device (hereinafter referred to as ‘execution device’) operating in an internal home network in a given transmission mode such as a streaming mode. The execution device decrypts the encrypted content and then freely uses the encrypted content.

The content encryption method performed in the home network may include a public key infrastructure (PKI) encryption method, a Universal Plug and Play (UPnP) security method and the like.

In such a home network, it is difficult to control unauthorized draining of content through unauthorized decryption or hacking that may be performed in the process of providing content from the content server to the execution device.

In particular, when content is copied in the execution device through an external storage device, the content is always exposed to unauthorized decryption or hacking, for which security of the content is more vulnerable.

Therefore, even though legitimate access to the content is allowed, there remains an increasing need to maintain the content's security in the process of providing content.

### SUMMARY OF THE INVENTION

The present invention addresses the aforementioned problems. To achieve this and other aspects of the present invention, there is provided a content copyright security system and method thereof, wherein content provided from a content server to an execution device is encrypted by a variety of encryption methods and the execution of the encrypted content in the execution device is made only when user authentication is performed through the content server and the execution device then receives an authentication key corresponding to one of the encryption methods from an authentication signal generating unit at a predetermined time interval, thereby maintaining security for the content even in the execution device.

Consistent with one aspect of the present invention, a content server connected to an external network encrypts a content file by a variety of encryption methods and then provides the encrypted content file through a security module. A content security processing unit of the execution device requests an authentication signal necessary for the execution of the encrypted content file.

The security module of the content server performs user authentication for a user of the execution device through an authentication processing unit and then transmits an authentication signal, which corresponds to one of the encryption methods applied to a content file, depending on the authentication results at a predetermined time interval.

As for the encryption method through the user authentication, a Kerveros method and the like are used. A decryption key necessary for the execution of content in the execution device is used as the authentication signal.

In the present invention, although it is described that the authentication signal generating unit is included in the security module of the content server consistent with an embodiment of the present invention, the authentication signal generating unit may be separately included in an external security server. At this time, since the operation of the authentication signal generating unit in the external security server is of the same as that in the content server, a description of the operation of authentication signal generating unit in the external security server will be omitted.

Consistent with another aspect of the present invention, there is provided a content copyright security system, comprising a content server that downloads a content file from an external network, encrypts the content file by means of a variety of encryption methods to provide an encrypted content file, and then transmits an authentication signal necessary for the execution of the content file in a predetermined time interval according to a request from a user, and an execution device that receives the content file from the content server, accesses the content server to request the authentication signal in order to execute the content file, and executes the content file using the authentication signal received from the content server.

Consistent with another aspect of the present invention, there is provided a content server, comprising a first control unit for performing operation control to decrypt a content file received through an external network, encrypt the file by a variety of encryption methods and then provide the encrypted content file to an execution device, an authentication processing unit for performing user authentication for determining whether the execution device that has received the encrypted content file is a user allowed to access the provided content file, under the control of the first control unit, when the execution device requests a user authentication key in order to execute the content file, and an encryption processing unit for encrypting the content file by a variety of encryption methods at a predetermined time interval, under the control of the first control unit.

The content server may further comprise an authentication signal generating unit for generating an authentication signal corresponding to one of the encryption methods used for the content file encrypted by the encryption processing unit, according to results of the user authentication in the authentication processing unit, and then providing the authentication signal to the execution device at a predetermined time interval.

Consistent with a further aspect of the present invention, there is provided an execution device, comprising a second control unit for performing the entire operation controlling the reception of an encrypted content file from a content server, and accessing an external server to request an authentication signal corresponding to an encryption method used for the content file in order to execute the encrypted content file, a reproducing unit for executing the content file using the authentication signal received from the content server, under the control of the second control unit, and a content security processing unit for accessing the external server and then requesting the authentication signal corresponding to the encryption method used for the content file after user authentication, in order to execute the encrypted content file, under the control of the second control unit.

Consistent with a still further aspect of the present invention, there is provided a content copyright security method, comprising causing an execution device to attempt to access a content server in order to execute a content file, if authentication confirmation is requested by the content server according to the access attempt, allocating a user authentication key to the execution device through user authentication of an external authentication server, and then causing the executing equipment to transmit the user authentication key to the content server, and after the user authentication using the user authentication key, allowing the execution device to receive the authentication signal transmitted at a predetermined time interval through an authentication signal generating unit of a security module and to execute the content file.

Consistent with a still further aspect of the present invention, there is provided a content copyright security method, comprising if an execution device attempts to connect with a content server in order to execute a content file, causing the content server to request a user authentication key to the execution device through an authentication processing unit, if the user authentication key is input by the execution device, causing the content server to perform a user authentication process using the input user authentication key, and according to results of the user authentication, causing the content server to transmit an authentication signal necessary for the execution of the content file to the authenticated user of the execution device through an authentication signal generating unit of a security module at a predetermined time interval.

### BRIEF DESCRIPTION OF THE DRAWINGS

The above and other aspects, features and advantages of the present invention will become apparent from the following description of exemplary embodiments given in conjunction with the accompanying drawings, in which:

FIG. 1 schematically illustrates the configuration of a content copyright security system consistent with an embodiment of the present invention;

FIG. 2 is a block diagram schematically illustrating the internal configuration of a content server consistent with an embodiment of the present invention;

FIG. 3 is a block diagram schematically illustrating the internal configuration of an execution device consistent with an embodiment of the present invention;

FIG. 4 is a flowchart schematically illustrating the process of executing a content file that has been stored beforehand, consistent with an embodiment of the present invention;

FIG. 5 is a flowchart schematically illustrating the process of receiving a content file from the content server, consistent with an embodiment of the present invention;

FIG. 6 schematically illustrates a content authentication processing procedure using the Kerberos method, consistent with an embodiment of the present invention;

FIG. 7 schematically illustrates a processing configuration for executing content stored in an authenticated execution device, consistent with one embodiment of the present invention; and

FIG. 8 schematically illustrates a processing configuration for executing content, which has been provided from the content server, in the authenticated execution device, consistent with another embodiment of the present invention.

### DETAILED DESCRIPTION OF THE INVENTION

Hereinafter, exemplary embodiments of the present invention will be described in detail in view of the aspects and constitutions thereof with reference to the accompanying drawings.

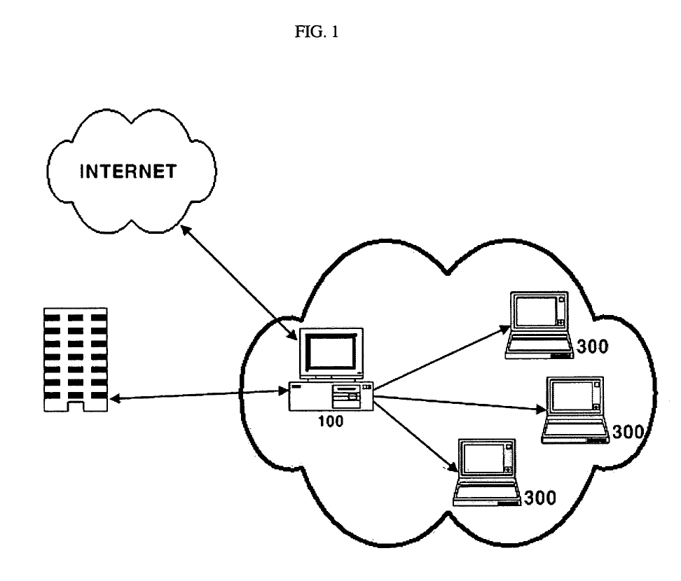

FIG. 1 schematically illustrates the configuration of a content copyright security system consistent with an embodiment of the present invention.

The content copyright security system comprises a content server 100 that downloads a given content file from an external network, encrypts the content file by means of a variety of encryption methods and provides the encrypted content file, and transmits at a regular interval of time an authentication signal necessary for execution of the content file at a user's request, and an execution device 300 that receives the given content from the content server 100 and gains access to the content server 100 to request an authentication signal and then executes the content file using the authentication signal provided from the content server 100 upon execution of the content file.

The content server 100 has a predetermined fixed Internet Protocol (IP) for connecting the external network and an internal network.

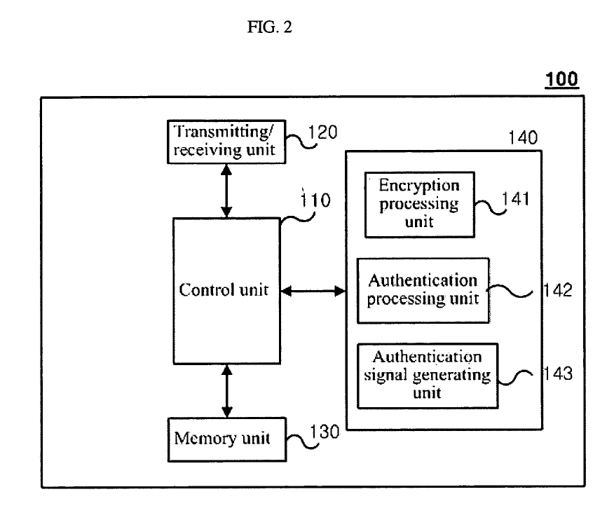

FIG. 2 is a block diagram schematically illustrating the internal configuration of a content server 100 consistent with an embodiment of the present invention.

As shown in FIG. 2, the content server 100 comprises a control unit (hereinafter, referred to as ‘first control unit’) 110, a transmitting/receiving unit (hereinafter, referred to as ‘first transmitting/receiving unit’) 120, a memory unit (hereinafter, referred to as ‘first memory unit’) 130, and a security module 140.

The first control unit 110 controls the overall operation to decrypt a content file received through the external network, encrypt the content file using a variety of encryption methods, transmit the encrypted content file to the execution device 300 of the internal network, and provide an authentication key corresponding to one of the encryption methods at a predetermined interval of time, at the request of the execution device 300 for executing the encrypted content file.

The first transmitting/receiving unit 120 receives a given content file from a specific content owner through the external network and transmits the encrypted content file and the authentication key necessary for the execution of the content file to the execution device 300 operating in the internal network, under the control of the first control unit 110.

The first memory unit 130 stores the content file downloaded from the external network and content service information containing user information under the control of the first control unit 110.

The security module 140 performs operations for keeping security of a content file under the control of the first control unit 110. The security module 140 comprises an encryption processing unit 141, an authentication processing unit 142 and an authentication signal generating unit 143.

The encryption processing unit 141 serves to encrypt a content file through a variety of encryption methods at a predetermined interval of time (random K time) or to encrypt the content file through predetermined encryption methods while changing an encryption period.

For example, part of a content file may be transmitted after being encrypted using a conventional PKI encryption method. After a lapse of a predetermined period of time, the remainder of the content file may be transmitted after being encrypted using an UPnP security type encryption method.

Furthermore, an encryption process for the content file is performed through the conventional Kerberos method at a constant or regular period. At this time, the Kerberos method may be continuously used or other encryption methods may be used.

In other words, in case of the Kerberos method, a ticket for user authentication having a predetermined period of validity is provided through an external authentication server. Thus, in order to execute the content file, the execution device 300 gains access to the content server 100, goes through user authentication by inputting the ticket and then receives the authentication signal from the content server 100.

In this case, due to the ticket with the period of validity, it is required that the execution device 300 again go through the authentication process through the content server 100 and receive the authentication signal after the period of validity has lapsed.

The authentication processing unit 142 performs a general user authentication process for providing content. Specifically, the authentication processing unit 142 performs the user authentication process of determining whether the user is a person who is allowed to access the content file, in order to provide the authentication signal necessary for the execution of the encrypted content in response to a request from the execution device 300 that has received the encrypted content file.

The authentication signal generating unit 143 generates an authentication key corresponding to the encryption method for the content file according to the results of the user authentication in the authentication processing unit 142, and then provides the authentication key at a predetermined interval of time.

The authentication signal is a kind of decryption key for decrypting the content encrypted by the encryption processing unit 141.

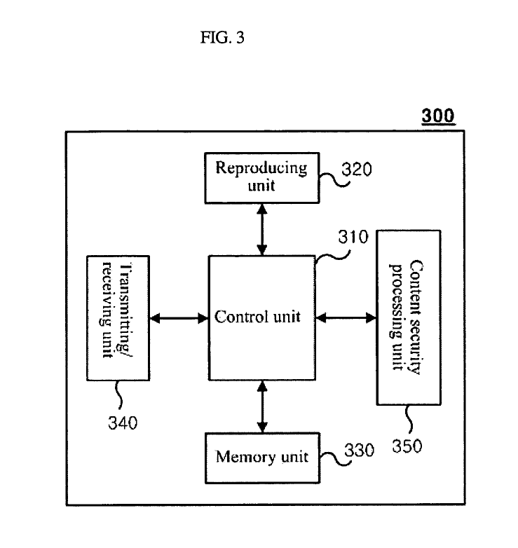

FIG. 3 is a block diagram schematically illustrating the internal configuration of an execution device consistent with an embodiment of the present invention.

As shown in FIG. 3, the execution device 300 comprises a control unit (hereinafter referred to as ‘second control unit’) 310, a reproducing unit 320, a memory unit (hereinafter, referred to as ‘second memory unit’) 330, a transmitting/receiving unit (hereinafter referred to as ‘second transmitting/receiving unit’) 340, and a content security processing unit 350.

The second control unit 310 receives an encrypted content file from the content server 100 and controls the overall operation for accessing the content server 100 and requests an authentication signal corresponding to an encryption method used for the content file in order to execute the encrypted content file.

The reproducing unit 320 executes a content file that has been stored in the second memory unit 330 or received from the content server 100, using the authentication signal received from the content server 100, under the control of the second control unit 310.

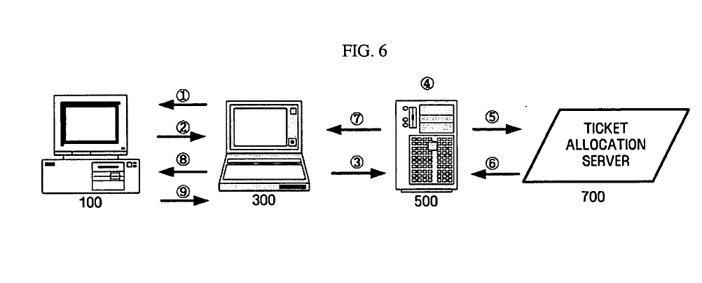

The second memory unit 330 stores the content file downloaded from the content server 100 and the user authentication key allocated by an authentication server 700 (see FIG. 6) in the process of user authentication, under the control of the second control unit 310.

The second transmitting/receiving unit 340 receives the content file and the authentication signal from the content server 100 and accesses the content server 100 in order to obtain the authentication signal, under the control of the second control unit 310.

When an encrypted content file that has been stored beforehand in the second memory unit 330 or received through the second transmitting/receiving unit 340 is executed, the content security processing unit 350 accesses the content server 100 and then requests the authentication signal corresponding to the encryption method after the user authentication, under the control of the second control unit 310.

Furthermore, in a case where the content file received from the content server 100 is to be stored in the second memory unit 330 or a certain external storage medium, an IP address of the content server 100 that has provided the content file is input into a header section of the content file.

In another embodiment of the present invention, if the authentication signal generating unit 143 of the security module 140 is included in a separate security server, the execution device 300 accesses the security server to receive the authentication signal necessary for the execution of the encrypted content file received from the content server 100.

For reference, all the respective modules of the content copyright security system consistent with the present invention may be constructed of hardware or software, or some of them may be constructed of software.

Therefore, it will be apparent to those skilled in the art that the construction of the content copyright security system consistent with the embodiment of the present invention using hardware or software does not depart from the scope and spirit of the invention, and that various modifications and changes in constructing the content copyright security system using hardware and/or software may be made without departing from the scope and spirit of the invention.

Hereinafter, a content copyright security method using the content copyright security system constructed as above will be described in detail with reference to the accompanying drawings.

The content copyright security method of the present invention comprises the process of allowing a user of the execution device 300 to execute a content file that has been stored beforehand and the process of allowing the user of the execution device 300 to access the content server 100, receive and store or execute a content file.

The process of executing the previously stored content file will be first described and the process of accessing the content server 100 and downloading or executing a content file will be then described.

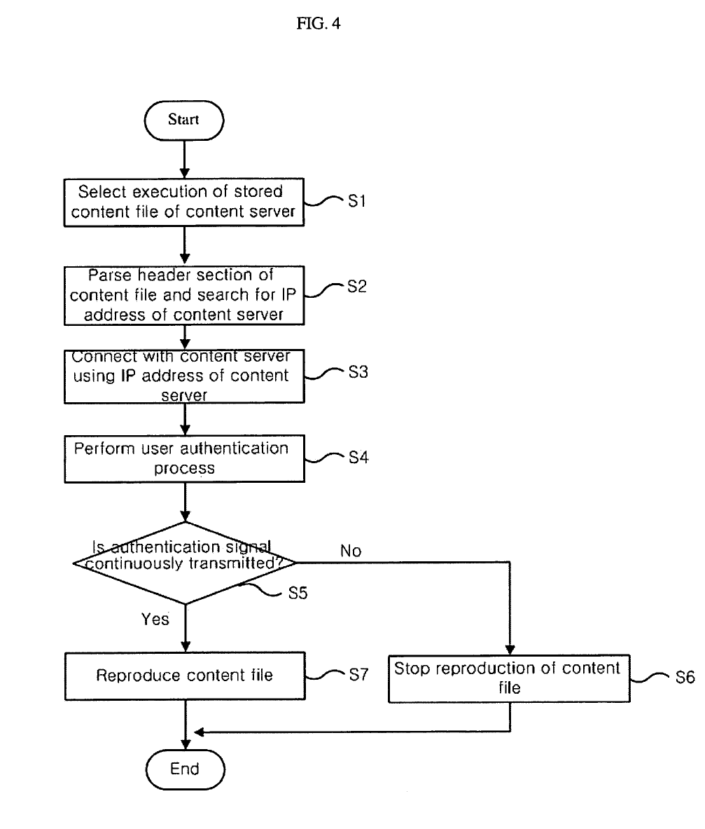

FIG. 4 is a flowchart schematically illustrating the process of executing a content file that has been previously stored, consistent with an embodiment of the present invention.

As shown in FIG. 4, a user of the execution device 300 selects a desired content file to be executed, among content files that have been stored beforehand in the second memory unit 330 in the execution device or an external storage medium (not shown) (S1).

According to the selection of a specific content file by the user, the second control unit 310 of the execution device 300 generates a relevant control signal and then transmits the signal.

Accordingly, the content security processing unit 350 of the execution device 300 parses the header section of the selected content file to search for an IP address of the content server 100 that provides an authentication signal necessary for the execution of the relevant content file (S2). Next, the content security processing unit 350 connects with the content server 100 using the searched IP address of the content server 100 (S3).

As the user of the execution device 300 connects with the content server 100, the authentication processing unit 142 of the content server 100 performs a user authentication process in order to confirm user authentication for the relevant content file.

According to the user authentication process, the content server 100 requests the user of the execution device 300 to send an authentication key such as a ticket for user authentication. The execution device 300 then accesses the external authentication server for user authentication.

The user of the execution device 300 who has accessed the authentication server inputs information such as a password, an IP address and a random hash value in the form of a packet. Depending on the input user information, the user of the execution device 300 receives a user authentication key from the authentication server and then transmits it to the content server 100.

The authentication processing unit 142 of the content server 100 utilizes the user authentication key input by the user of the execution device 300 to perform the user authentication for the relevant content file, and then transmits authentication results to the authentication signal generating unit 143.

When the user authentication has been performed through the above procedures (S4) and the user authentication has been successfully made, the authentication signal generating unit 143 of the content server 100 issues the authentication signal necessary for the execution of the content file in the execution device 300.

Accordingly, the execution device 300 executes the content file using the authentication signal received from the content server 100. Further, the content security processing unit 350 of the execution device 300 determines whether the authentication signal is continuously received from the content server 100 (S5).

If it is determined that the authentication signal is not continuously received, the execution of the content file is stopped (S6). If it is determined that the authentication signal is continuously received, the execution of the content file is maintained (S7).

In other words, to obtain the authentication signal necessary for the execution of the content file, which has been encrypted according to the encryption method for the content file of the content server 100, from the content server 100, the execution device 300 accesses the content server 100 at a predetermined interval of time.

Accordingly, the content server 100 provides the authentication signal corresponding to the encryption method after the user authentication so that the content file can be executed in the relevant execution device 300.

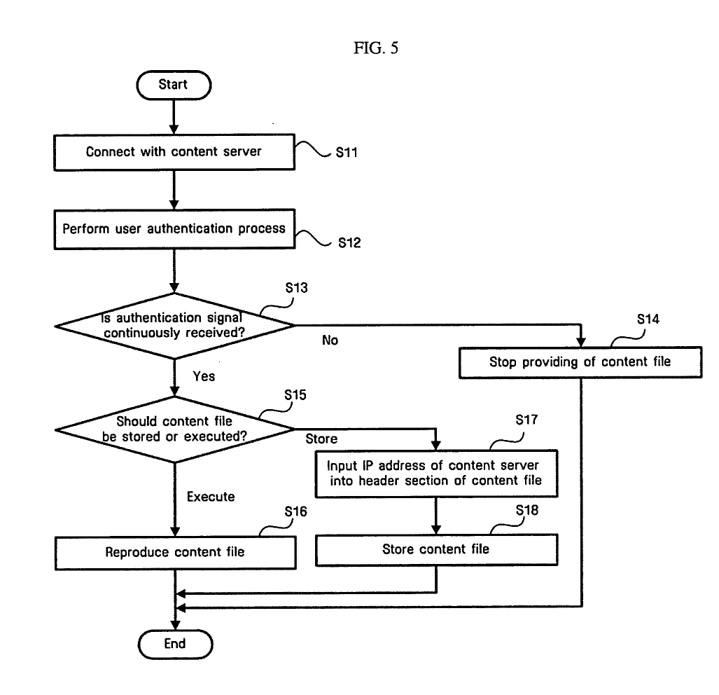

FIG. 5 is a flowchart schematically illustrating the process of receiving a content file from the content server, consistent with an embodiment of the present invention.

As shown in FIG. 5, the execution device 300 first connects with the content server 100 to download and store or execute a specific content file provided from the content server 100 (S11).

According to such a connection request from the user of the execution device 300, the content server 100 requests a user authentication key in order to perform user authentication for the user of the execution device 300.

According to the request from the content server 100, the execution device 300 accesses a predetermined authentication server and then inputs information such as a password, an IP address and a random hash value in the form of a packet. The execution device 300 consequently receives the user authentication key.

When the user authentication key is received, the execution device 300 inputs its own user authentication key into the content server 100. The authentication processing unit 142 of the content server 100 then performs the user authentication process of determining whether the user of the execution device 300 is a subscriber to a content service, using the authentication key of the user of the execution device 300 (S12).

After the user authentication is completed through the above procedure, the content server 100 transmits results of the user authentication for the content file to the authentication signal generating unit 143 of the content server and then provides the content file selected by the user of the execution device 300.

Accordingly, the content server 100 generates an authentication signal through the authentication signal generating unit 143 and transmits the authentication signal along with the content file thereof.

The execution device 300 receives the content file and the authentication signal and determines whether the authentication signal is continuously received from the content server 100 (S13).

If it is determined that the authentication signal is not continuously received, the reception of the content file is stopped (S14). If it is determined that the authentication signal is continuously received, the reception of the content file is maintained and it is determined whether to store or execute the content file being received (S15).

If it is determined that the user selects a storage button, an IP address of the content server 100 is input into a header section of the received content file (S17) and the resultant content file is then stored in the second memory unit 330 (S18).

If it is determined that the user selects an execution button, the execution device executes the received content file (S18).

FIG. 6 schematically illustrates a content authentication processing procedure using the Kerberos method, consistent with an embodiment of the present invention.

As shown in FIG. 6, a content security system using the Kerberos method further comprises an authentication server 500 and a ticket allocation server 700, which are used to authenticate a user of the execution device 300.

When the user of the execution device 300 wants to receive a content file from the content server 100, the user of the execution device 300 issues a connection request to the content server 100 (\mathring{1}).

According to the connection request from the user of the execution device 300, the content server 100 requests a ticket for user authentication (\mathring{2}). According to the ticket request from the content server 100, the execution device 300 inputs a password into the authentication server 500 and then requests user authentication, in order to obtain a ticket for user authentication (\mathring{3}).

In response to the request from the user of the execution device 300, the authentication server 500 generates a session key using the password input by the user (\mathring{4}) and then transmits the generated session key to the ticket allocation server 700 (\mathring{5}).

The ticket allocation server 700 transmits the ticket for user authentication to the authentication server 500 by using the received session key (\mathring{6}). The authentication server 500 then transmits the received ticket for user authentication to the execution device 300 (\mathring{7}).

Next, the execution device 300 transmits the ticket for user authentication, which has been received from the authentication server 500, to the content server 100 (\mathring{8}). Then, the content server 100 recognizes the user of the execution device 300 as a content user based on the input ticket and then provides the user of the execution device 300 with an authentication signal and a content file received through the Internet, a cable or the like (\mathring{9}).

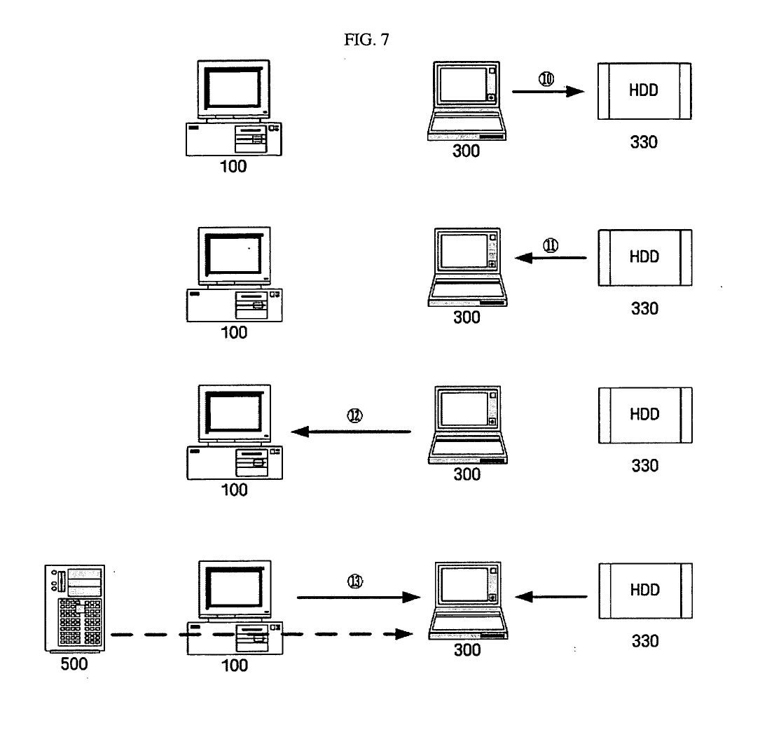

FIG. 7 schematically illustrates a processing configuration for executing content stored in authenticated execution device, consistent with one embodiment of the present invention.

As shown in FIG. 7, in a case where a user of the execution device 300 wants to execute a content file stored in the second memory unit 330 such as a hard disk (HDD), the execution device 300 selects execution of the content file stored in the second memory unit 330 (\mathring{10}).

According to the user's selection of execution, the execution device 300 searches for an IP address of the content server 100 from a header section of the relevant content file in order to execute the content file, and then requests a security signal necessary for the execution of the content file by using the searched IP address of the content server 100 (\mathring{11}).

Accordingly, the execution device 300 requests an authentication signal necessary for the execution of the content file of the content server 100 by using the searched IP address of the content server 100 (\mathring{12}). In response to the request from the user of the execution device 300, the content server 100 authenticates the user and then transmits the authentication signal through the authentication signal generating unit 143 at a predetermined interval of time (\mathring{13}).

When the execution device 300 receives the authentication signal from the content server 100, it executes the relevant content file stored in the second memory unit 330.

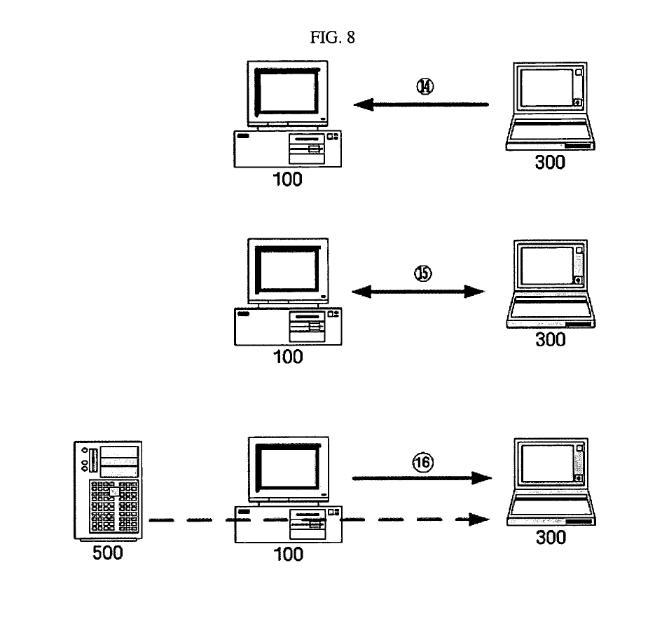

FIG. 8 schematically illustrates a processing configuration for executing content, which has been provided from the content server, in the authenticated execution device, consistent with another embodiment of the present invention.

As shown in FIG. 8, when a user of the execution device 300 accesses the content server 100 to receive a content file from the content server 100, the user of the execution device 300 issues an access request to the content server 100 (\mathring{14}).

In response to the access request from the user of the execution device 300, the content server 100 requests a ticket for user authentication. The execution device 300 then inputs a ticket for user authentication that has been received from the authentication server 500 (\mathring{15}).

The content server 100 authenticates the user using the input ticket for user authentication, provides a content file selected by the user and then transmits a security signal to the execution device 300 through the authentication signal generating unit 143 (\mathring{16}).

Consistent with the present invention described above, in case of execution of a content file received from a content server, the content file can be executed only when an authentication signal corresponding to an encryption method is received from the content server. Thus, it is possible to effectively prevent unauthorized hacking, copying or the like of content.

Even though unauthorized hacking or copying of content has been made, an authentication signal cannot be continuously received from the content server. For this reason, the content could be executed just before the time when the authentication signal is transmitted to execution device according to a next period. That is, the content could not be executed continuously. Thus, it is expected to reduce such behaviors as unauthorized hacking or copying of the content.

Although the present invention has been described in connection with the exemplary embodiments of the present invention, it will be apparent to those skilled in the art that various modifications and changes may be made thereto without departing from the scope and spirit of the invention defined by the appended claims. Therefore, simple changes of the embodiments of the present invention fall within the scope of the present invention.

1. A content server, comprising:
a first control unit operable to perform operation control to decrypt a content file received through an external network, encrypt the file by a variety of encryption methods and provide the encrypted content file to an execution device;
an authentication processing unit operable to perform user authentication to determine whether the execution device is allowed to access the provided content file, when the execution device that has received the encrypted content file under the control of the first control unit requests a user authentication key in order to execute the content file; and
an encryption processing unit operable to encrypt the content file by a variety of encryption methods at a predetermined interval of time, under the control of the first control unit.

2. The content server as claimed in claim 1, further comprising an authentication signal generating unit operable to generate an authentication signal corresponding to one of the encryption methods used for the content file encrypted by the encryption processing unit, according to results of the user authentication in the authentication processing unit, and providing the authentication signal to the execution device at a predetermined interval of time.

3. The content server as claimed in claim 1, wherein the encryption processing unit encrypts the content file using a given encryption method while changing an encryption period.

4. The content server as claimed in claim 2, wherein the authentication signal generating unit generates the authentication signal corresponding to one of the encryption methods of the encryption processing unit or according to an encryption period of the encryption processing unit.

5. The content server as claimed in claim 2, wherein the authentication signal is a decryption key operable to decrypt the content file encrypted by the encryption processing unit.

6. An execution device, comprising:
a second control unit operable to perform the entire operation of controlling the reception of an encrypted content file from a content server, and accessing an external server to request an authentication signal corresponding to an encryption method used for the content file in order to execute the encrypted content file;
a reproducing unit operable to execute the content file using the authentication signal received from the content server, under the control of the second control unit; and
a content security processing unit operable to access the external server and request the authentication signal corresponding to the encryption method used for the content file after user authentication, in order to execute the encrypted content file, under the control of the second control unit.

7. The device as claimed in claim 6, wherein the external server is a content server comprising an authentication signal generating unit that generates the authentication signal corresponding to the encryption method used for the encrypted content file and provides the authentication signal to the execution device at a predetermined interval of time.

8. The device as claimed in claim 6, wherein the external server is a security server comprising an authentication signal generating unit that generates the authentication signal corresponding to the encryption method used for the encrypted content file and provides the authentication signal to the execution device at a predetermined interval of time.

9. The device as claimed in claim 7, wherein the authentication signal generating unit generates an authentication signal corresponding to the encryption method of the content server or according to an encryption period in the content server.

10. The device as claimed in claim 8, wherein the authentication signal generating unit generates an authentication signal corresponding to the encryption method of the content server or according to an encryption period in the content server.

11. A content copyright security system, comprising:
a content server that downloads a content file from an external network, encrypts the content file by a variety of encryption methods to provide an encrypted content file, and transmits an authentication signal necessary for the execution of the content file in a predetermined interval of time according to a request from a user; and
an execution device that receives the content file from the content server, accesses the content server to request the authentication signal in order to execute the content file, and executes the content file using the authentication signal received from the content server.

12. The system as claimed in claim 11, wherein the content server comprises:
a first control unit operable to perform operational control of decrypting the content file received through the external network, encrypting the file by means of a variety of encryption methods and providing the encrypted content file to the execution device;
an authentication processing unit operable to perform user authentication to determine whether the execution device is allowed to access the provided content file, when the execution device that has received the encrypted content file under the control of the first control unit requests a user authentication key in order to execute the content file; and
an encryption processing unit operable to encrypt the content file by means of a variety of encryption methods at a predetermined interval of time, under the control of the first control unit; and
an authentication signal generating unit operable to generate the authentication signal corresponding to one of the encryption methods used for the content file encrypted by the encryption processing unit, according to results of the user authentication in the authentication processing unit, and then providing the authentication signal to the execution device at a predetermined time interval.

13. The system as claimed in claim 12, wherein the execution device comprises:
a second control unit operable to perform entire operational control to receive the encrypted content file from the content server, and accessing the content server to request the authentication signal corresponding to one of the encryption methods used for the content file in order to execute the encrypted content file;
a reproducing unit operable to execute the content file using the authentication signal received from the content server, under the control of the second control unit; and
a content security processing unit operable to access the content server and requesting the authentication signal corresponding to the encryption method used for the content file after the user authentication, in order to execute the encrypted content file, under the control of the second control unit.

14. A content copyright security method, comprising:
causing an execution device to attempt to access a content server in order to execute a content file;
if authentication confirmation is requested by the content server according to the access attempt, allocating a user authentication key to the execution device through user authentication of an external authentication server, and causing the execution device to transmit the user authentication key to the content server; and
after the user authentication using the user authentication key, allowing the execution device to receive the authentication signal transmitted at a predetermined interval of time through an authentication signal generating unit of a security module and to execute the content file.

15. The method as claimed in claim 14, wherein attempting to access the content server comprises:
causing the execution device to search a header section of a content file to be executed and to detect an Internet Protocol (IP) address of the content server; and
causing the execution device to connect with the relevant content server using the detected IP address of the content server.

16. The method as claimed in claim 14, wherein executing the content file comprises determining whether the authentication signal is continuously received from the authentication signal generating unit of the security module at a predetermined interval of time.

17. The method as claimed in claim 14, wherein the authentication signal generating unit generates the authentication signal corresponding to an encryption method of the content server or according to an encryption period in the content server.

18. A content copyright security method, comprising:
if an execution device attempts to connect with a content server in order to execute a content file, causing the content server to request a user authentication key to the execution device through an authentication processing unit;
if the user authentication key is input by the execution device, causing the content server to perform a user authentication process using the input user authentication key; and
according to results of the user authentication, causing the content server to transmit an authentication signal necessary for the execution of the content file to the authenticated user of the execution device through an authentication signal generating unit of a security module at a predetermined time interval.

19. The method as claimed in claim 18, wherein the content server encrypts the content file by a variety of encryption methods at a predetermined interval of time through an encryption processing unit, or encrypts the content file using a predetermined encryption method while changing an encryption period.

20. The method as claimed in claim 19, wherein the authentication signal generating unit generates the authentication signal corresponding to one of the encryption methods of the content server or according to the encryption period in the content server.
